(19) United States
(12) Patent Application Publication
(10) Pub. No.: US 2025/0351833 A1
(43) Pub. Date: Nov. 20, 2025

(54) FENNEL OIL LOADED POLYMERIC BEAD FORMULATION FOR INSECTICIDAL ACTIVITY AND PROCESS OF PREPARATION THEREOF

(71) Applicant: COUNCIL OF SCIENTIFIC & INDUSTRIAL RESEARCH, New Delhi (IN)

(72) Inventors: Narayan Prasad YADAV, Lucknow (IN); Megha ADE, Lucknow (IN); Vandana SINGH, Lucknow (IN); Debasish SAHOO, Lucknow (IN)

(21) Appl. No.: 19/209,317

(22) Filed: May 15, 2025

(30) Foreign Application Priority Data
May 15, 2024 (IN) 202411038351

(51) Int. Cl. A01N 65/10; A01N 25/10; A01N 25/12; A01N 25/30; A01P 7/04

(52) U.S. Cl. CPC A01N 65/10; A01N 25/10; A01N 25/12; A01N 25/30; A01P 7/04

(57) ABSTRACT

The present work discloses polymeric bead formulation and process for preparation the same. The polymeric bead formulation comprise fennel oil as a extended release system for insecticidal activity against Aedes agypti, Anopheles stephensi, and wild mosquito larvae. This study was carried out by emulsifying fennel oil in an aqueous sodium alginate solution blended with HPMC and the fabrication of beads was then followed by an ionotropic gelation method using CaCl₂ as a cross-linker. The in-vivo larvicidal bioassay showed that the fennel oil-loaded polymeric beads resulted in 100% mortality of Aedes agypti, Anopheles stephensi, and wild mosquito larvae within 24 hours. These results confirm that the fennel oil-loaded polymeric beads exhibited good entrapment efficiency, extended release property, and excellent insecticidal activity.

### CROSS-REFERENCE TO RELATED APPLICATIONS

The present application is based upon and claims the right of priority to IN patent application Ser. No. 202411038351, filed May 15, 2024, the disclosure of which is hereby incorporated by reference herein in its entirety for all purposes.

### FIELD OF THE INVENTION

The present invention relates to a formulation comprising of biodegradable polymers and food-grade fennel oil for insecticidal activity. Particularly the present invention relates to a formulation that is effective against different species of mosquitoes. More particularly the present invention relates to a process of a product comprising fennel oil with polymers in different ratios. Further, the invention relates to the effect of said composition on the mosquito larvicidal activity of different species and helping in the reduction of mosquitoes population.

### BACKGROUND OF THE INVENTION

Fennel (Foeniculum vulgare Mill.) is a traditional and well-known aromatic plant with a long history of medicinal use belonging to the family Apiaceae and is among the most widespread medicinal plant worldwide (Ahmad et al., 2018). Numerous studies have shown that F. vulgare effectively controls a wide range of infectious diseases caused by bacteria, fungi, viruses, and many others, as well as used as food additives and flavoring agents (Badgujar et al., 2014). Additionally, fennel oil is widely considered for its great effectiveness against mosquitoes and has proven a considerable alternative for mosquito larvicidal activity (Pavela, 2015; Pitasawat et al., 2007; Rocha et al., 2015). The main disadvantage of using fennel oil for larvicidal or mosquito-repellent activity is that fennel oil has substantial volatility and degrades readily and must be replaced frequently, resulting in significant fennel oil loss (Sun et al., 2021).

Exploring the possibility of creating a conventional formulation that can control the mosquitoes is extensively being investigated. As a result, the entrapment of fennel oil in polymeric beads has evolved as a promising approach for extending the stability and therapeutic efficacy of fennel oil, and a prolonged delivery system would certainly provide an adequate larvicidal dose (Paula et al., 2012). Several studies have reported the utilization of naturally occurring anionic biodegradable polymers such as sodium alginate, chitosan, xanthan gum, soy protein, or polymer combinations for the development of the beads. Sodium alginate carries intriguing physicochemical properties, such as widespread availability, chemical stability, inexpensiveness, and has good gel barrier-forming ability. Thus, considered for the encapsulation purpose of volatile oils to protect them from temperature variations, oxidation, and moisture, resulting in long-term stability. (Paula et al., 2012). Alginate is composed of linear chains of -L-guluronic acid and -D-mannuronic acid residues joined by 1, 4-glycosidic linkages. Sodium alginate has a low emulsifying ability (Belščak-Cvitanović et al., 2015). The low emulsifying ability of alginate can be compensated by combining alginate with complementary biopolymers (Volić et al., 2018). Hydroxypropylmethylcellulose (HPMC) has received the most attention and is considered for the fortification of formulations. HPMC is a non-ionic cellulose derivative and has wide application in drug formulations due to its solubility in water, biocompatibility, and rheological properties (Tundisi et al., 2021). It is used as a viscosity modifier, drug release modifier, thickening agent, binder, and film former. HPMC has also received GRAS-affirmed approval from the Food and Drug Administration (FDA) (Ghorpade et al., 2016, Ghadermazi et al., 2019). In this study, HPMC is used as a co-polymer to enhance the thickening of the emulsion to get the desired consistency prior to bead preparation. HPMC can also be employed as a matrix for controlling the release of hydrophobic drugs such as essential oils (Kaur et al., 2018).

Many studies have been reported where sodium alginate (SA) and HPMC-based formulations are developed. In one of the studies, HPMC was blended with sodium alginate for controlled and modified drug release of ceftriaxone sodium (Patel et al., 2016). In another study, sodium alginate and HPMC-based in-situ gelling ophthalmic delivery system was prepared for the delivery of gatifloxacin (Zhidong et al., 2016). Hu et al. (2018), developed an HPMC-SA composite hydrogel drug carrier with higher drug-loading capacity and better-sustained release ability of bovine serum albumin, metformin hydrochloride, and indomethacin. For the confinement of fennel oil in beads, the ionotropic gelation method is used, which promotes the chemical interaction between negatively charged alginate and Ca²⁺ ions. CaCl₂ is chosen as a cross-linking agent for the development of polymeric beads due to its lack of toxicity as compared to other cations and it effectively binds with both G-and MG-blocks of alginate, forming a strong hydrogel network which can safely encase the fennel oil (Auriemma et al., 2020).

The main concern with utilizing fennel oil for insecticidal activity is that it is volatile and degrades quickly. To overcome this issue, the entrapment of fennel oil in polymeric beads will be a potential technique for increasing the stability of fennel oil to achieve extended release and prolonged insecticidal activity.

Pascual-Villalobos et al. (2020), work was aimed to formulate (E)-anethole as solid microparticles (by three methods-oil emulsion entrapment, spray drying or molecular inclusion with β-cyclodextrin) and test the potential of the vapour released as aphicide on pepper leaves. Experiments were implemented with the green peach aphid, Myzus persicae Sulzer (Hemiptera: Aphididae), one of the main pests worldwide attacking fruit trees and vegetables and causing direct damage and transmission of virus diseases.

Pascual-Villalobos et al. (2021), presented two (E)-anethole formulations (spray drying (SD) and oil emulsion entrapment (OEE) processes) that provide a controlled release of their bioactive ingredient in the vapour phase with insecticidal potential in funnel traps. The work described testing of insecticidal activity of (E)-anethole formulations against aphids, and the best method of formulation was the oil emulsion entrapment (OEE) method. This work provides the information on the potential of (E)-anethole as an insecticide in the vapour phase when formulated for a controlled release inside funnel traps.

Báez et al. (2019), developed emulgels formulated with sweet fennel oil and rhamsan gum, a biological macromolecule produced by Sphingomonas. These bioactive sweet fennel oil-in-water emulsions and emulgels were formulated for active ingredient delivery with potential applications in the food industry.

Radwan et al. (2022) studied and evaluated the novel larvicidal and adulticidal activity of fennel and green tea oils and their nanostructured lipid carriers (NLC) against Culex pipiens (C. pipiens) in the laboratory, field conditions and evaluated their effect against non-target organisms.

Sun et al. (2021) reported fennel essential oil loaded porous starch-based microencapsulation as an efficient delivery system for the quality improvement of ground pork. Porous starch (PS) was used as the core material carrier to adsorb fennel essential oil (FEO). Using sodium alginate (SA)-chitosan (CS) as the wall material and glutaraldehyde as the curing cross-linking agent, CS/SA/PS-FEO microcapsules were successfully prepared by polyelectrolyte complex coagulation method. The beads formation process, structural properties and release behaviour of CS/SA/PS-FEO microcapsules were analysed.

### OBJECTIVES OF THE INVENTION

The main objective of the present invention was to formulate polymeric beads loaded with fennel essential oil

Another objective of the present invention was to increase the stability of fennel oil to achieve extended release and prolonged insecticidal activity.

Yet another objective of the present invention was to evaluate the insecticidal activity against Aedes agypti, Anopheles stephensi, and wild mosquito larvae.

### SUMMARY OF THE INVENTION

Accordingly the present invention provides a fennel oil-loaded polymeric beads for mosquito larvicidal activity wherein the said beads are in the size range of 1.49 mm to 1.86 mm wherein the said beads comprise food-grade fennel oil, biodegradable polymers, surfactant and cross linker in the range of 0.0-14.0% v/v, 1.0-5.0% w/v and 0.025-3.0% w/v, 0.5-2.0% w/v respectively.

In an embodiment of present invention the entrapment efficiency of dried beads was 53.90-79.08% and its loading capacity was 47.7-78.56%.

In another embodiment of present invention the said polymeric beads demonstrated extended in-vitro release of the fennel oil from the beads with cumulative release of fennel oil in the range of 52.90% to 91.66% in a period in the range of 4 to 72 hours.

In yet another embodiment of present invention the said beads are effective in controlling Aedes agypti, Anopheles stephensi, and wild mosquito larvae and provide 100% mortality of Aedes aegypti, Anopheles stephensi, and wild mosquito larvae within 24 hours of contact.

In yet another embodiment, the present invention provides a process for preparing micro spherical polymeric beads as claimed in claim 1, wherein the said process comprises with steps of
i. mixing 1.0-3.0% v/v of PEG 400 with 0.0-14.0% v/v of fennel oil to obtain a solution,
ii. mixing solution obtained in step (i) with 1.0-5.0% w/v sodium alginate and 0.1-2.0% w/v HPMC and stirring at 1200-1500 rpm for 30 minutes at temperature in the range of 25-35° C. followed by sonicating for 10 mins on ice bath to obtain a micro emulsion,
iii. fabricating beads by adding the micro emulsion obtained in step (ii) dropwise in cross-linking solution of 0.5-2.0% w/v CaCl₂ to obtain wet polymeric beads,
iv. washing the polymeric beads obtained in step (iii) and shade drying the same at temperature in the range of 25-35° C. after decanting excess CaCl₂ crosslinking solution to obtain dried fennel oil loaded beads.

In still another embodiment of present invention the polymers are selected from sodium alginate, HPMC, chitosan, guar gum, and CMC (Carboxymethyl cellulose).

In still another embodiment of present invention the surfactant is selected from Span 20, Span 80, PEG 400, Cremophor RH 40, and Tween 20.

In still another embodiment of present invention the crosslinking solution used is CaCl₂.

### BRIEF DESCRIPTION OF THE DRAWINGS

FIG. 1 shows the droplet size distribution of non-sonicated and sonicated emulsions using optical microscopy.

FIG. 2 demonstrates particle size distribution of the emulsion using a Malvern Zeta Sizer.

FIG. 3 represents SEM images of fennel oil loaded dried beads exhibiting size range of polymeric beads (A and C) with their respective images on higher magnification (B and D)

FIG. 4 illustrates the release pattern of fennel oil-loaded polymeric beads

### DETAIL DESCRIPTION OF THE INVENTION

The present invention relates to a composition comprising of Fennel oil entrapped within biodegradable polymer beads for mosquito larvicidal activity against different species of mosquitoes. Fennel (Foeniculum vulgare Mill.) is a traditional and well-known aromatic plant with a long history of medicinal use belonging to the family Apiaceae (1).

According to an embodiment of the present invention, polymeric beads based on essential oil of Foeniculum vulgare Mill is prepared by the ionotropic gelation method. The present invention relates to fennel oil-based polymeric bead formulation for insecticidal activity.

The present invention provides a fennel oil-loaded polymeric beads for mosquito larvicidal activity wherein the said beads are in the size range of 1.49 mm to 1.86 mm wherein the said beads comprise food-grade fennel oil, biodegradable polymers, surfactant and cross linker in the range of 0.0-14.0% v/v, 1.0-5.0% w/v and 0.025-3.0% w/v, 0.5-2.0% w/v respectively, wherein the entrapment efficiency of dried beads was 53.90-79.08% and its loading capacity is 47.7-78.56% and the said polymeric beads demonstrated extended in-vitro release of the fennel oil from the beads with cumulative release of fennel oil in the range of 52.90% to 91.66% in a period in the range of 4 to 72 hours.

This study was carried out by emulsifying fennel oil in an aqueous sodium alginate solution blended with HPMC and the fabrication of beads was then followed by an ionotropic gelation method using CaCl₂ as a cross-linker. The concentrations of sodium alginate, HPMC, and CaCl₂ were taken as process parameters. The alginate emulsion was characterized based on the particle size (363.8±6.60 nm), polydispersity index (0.349±0.021), and viscosity (4518±269 cps at 100 rpm). The prepared beads were characterized by scanning electron microscopy (SEM) for the surface topographical study. The beads were further evaluated for % EE (79±0.22% %) and loading capacity (78.56±0.309) and in-vitro drug release (91.66±0.47% in 72 hours). The in-vivo larvicidal bioassay showed that the fennel oil-loaded polymeric beads resulted in 100% mortality of Aedes agypti, Anopheles stephensi, and wild mosquito larvae within 24 hours. These results confirm that the fennel oil-loaded polymeric beads exhibited good entrapment efficiency, extended release property, and excellent insecticidal activity.

The following description embodies the best mode of the present invention. Reference now will be made in detail to embodiments of the invention, one or more examples of which are illustrated in the drawings. In the present invention, polymeric beads loaded with fennel oil is prepared and its in-vivo insecticidal property is evaluated.

The selection of polymer, co-polymer, and surfactant was done based on parameters such as viscosity and thickness of the emulsion, miscibility of oil with the aqueous phase, as well as hydrogel network formation, which will result in a spherical shape and uniform size distribution of beads. Several pilot batches of beads were prepared using various polymers, such as chitosan and sodium alginate. After selecting sodium alginate for gel network formation, five different combinations of sodium alginate with HPMC, guar gum, CMC, and chitosan were prepared to select an efficient thickening agent and swelling enhancer, and one batch using sodium alginate alone was also prepared. The list of ingredients used in present invention their source is given below:
1. Sodium alginate was procured from Sigma-Aldrich Chemicals Pvt. Ltd. Bangalore, India
2. Fennel oil was Purchased from Ayuroma Centre, 116/317, Adarsh Nagar, Rawatpur Gaon, Kanpur, Uttar Pradesh, India-208019
3. Guar Gum (Guar gum powder of Endosperm) was procured from CDH Central Drug House (P) LTD. Post Box no. 7138, New Delhi-110002
4. CMC (Carboxymethylcellulose Sodium Salt) was procured from CDH Central Drug House (P) LTD. Post Box no. 7138, New Delhi-110002
5. Chitosan (Medium Molecular Weight) was procured from Sigma-Aldrich Chemicals Private Limited, Bommasandra Jigani Link Road, Industrial Area, Anekal Taluk, Bangalore
6. HPMC (Hydroxypropyl)methyl cellulose was procured from HIMEDIA HiMedia Laboratories Private Limited, Plot No. C40, Road No. 21Y, MIDC, Wagle Industrial Estate, Thane (West)-400604, Maharashtra, India
7. Span 20 was procured from SDFCL SDFCL Marathon Icon, 1502, Lower Parel West, Lower Parel, Mumbai 400013, Maharashtra, India
8. Span 80 was procured from SDFCL SDFCL Marathon Icon, 1502, Lower Parel West, Lower Parel, Mumbai 400013, Maharashtra, India
9. PEG 400 was procured from HIMEDIA HiMedia Laboratories Private Limited, Plot No. C40, Road No. 21Y, MIDC, Wagle Industrial Estate, Thane (West)-400604, Maharashtra, India
10. Cremophor RH 40 was procured from HIMEDIA HiMedia Laboratories Private Limited, Plot No. C40, Road No. 21Y, MIDC, Wagle Industrial Estate, Thane (West)-400604, Maharashtra, India
11. Tween 20 was procured from HIMEDIA HiMedia Laboratories Private Limited, Plot No. C40, Road No. 21Y, MIDC, Wagle Industrial Estate, Thane (West)-400604, Maharashtra, India
12. Glycerol was procured from SDFCL SDFCL Marathon Icon, 1502, Lower Parel West, Lower Parel, Mumbai 400013, Maharashtra, India

The composition of the beads was optimized by modifying parameters such as combination with other polymers, and the concentration of the cross-linking agent. The sodium alginate and HPMC blend were finalized based on the consistency (viscosity and thickness) of the emulsion formed before beads development and the formation of spherical and uniform-sized beads. A viscous and thick emulsion is required to form a stable emulsion so that the coalescence can be avoided by increasing viscosity and forming a protective layer around dispersed droplets (Chan, 2011, Huang et al., 2001). Various trials were taken by varying the concentrations of sodium alginate and HPMC, and a concentration ratio of 4:0.6% (w/v) was optimized as the final polymer combination to develop the desired formulation. Surfactants such as Span 20, Span 80, PEG 400, Cremophor RH 40, and Tween 20 were tested to choose a surfactant with maximum solubility in both phases to prepare a stable emulsion. PEG 400 was chosen as a surfactant because of its good solubility in both phases.

Crosslinking sodium alginate and calcium chloride with optimal concentrations contributed to develop spherical beads of uniform shape and size that were reduced almost two folds in size when dried. Various factors were to be considered while optimizing the fabrication conditions of the beads. Factors such as the concentration of sodium alginate and the concentration of CaCl₂ play important roles. Sodium alginate in 1% (w/v), 2% (w/v), 3% (w/v), 3.5% (w/v), 4% (w/v), and CaCl₂ in 0.5% (w/v), 1.0% (w/v) and 1.5% (w/v) concentrations were taken for the trial.

CaCl₂ was used as a cross-linker agent to prepare polymeric beads by promoting cross-linking between alginate and Ca+ions (Gholamian et al., 2021). Adding CaCl_{2 <1}% (w/v) was ineffective in generating beads; on the contrary, applying a large amount of CaCl₂caused excessive shrinkage of the beads during beads formation and forming creases on the bead surface, which also caused the oil loss in the solution. The experiment demonstrated that maintaining the concentration of sodium alginate (4% w/v), and HPMC (0.6% w/v), PEG 400 (1.5% v/v) showed good dispersion of fennel oil (10%) in the emulsion and helped in round beads fabrication (Table 1).

Effect of polymer, co-polymers, surfactant, fennel oil and cross-linking agent on bead formation was studied

### EXAMPLES

The following examples are given by way of illustration and therefore should not be construed to limit the scope of the present invention.

### Example 1

The example provides effect of polymer, co-polymers, surfactant, fennel oil and cross-linking agent on bead formation depicted in table 1.

TABLE 1
Effect of polymer, co-polymers, surfactant, fennel oil and cross-linking agent
on emulsion and polymeric bead formation
Composition of emulsion and polymeric beads

| | Sodium | PEG | | | | | Gaur | Fennel | |
|---|---|---|---|---|---|---|---|---|---|
| Batch | Alginate | 400 | CaCl₂ | Chitosan | CMC | HPMC | Gum | oil | Obser- |
| Code | (% w/v) | (% v/v) | (% w/v) | (% w/v) | (% w/v) | (% w/v) | (% w/v) | (% v/v) | vation |
| F1 | 1 | 1 | 0.5 | — | — | — | — | 0-14 | The beads |
| | 2 | 1.5 | 1 | | | | | | were not |
| | 3 | 2 | 1.5 | | | | | | spherical |
| | 4 | 2.5 | 2 | | | | | | and got |
| | 5 | 3 | | | | | | | elongated |
| | | | | | | | | | and |
| | | | | | | | | | flattened |
| F2 | 1 | 1.5 | 1.5 | 0.1 | — | — | — | 0-14 | Improper |
| | 2 | | | 0.2 | | | | | bead |
| | 3 | | | 0.3 | | | | | formation |
| | 4 | | | 0.4 | | | | | |
| | 5 | | | 0.5 | | | | | |
| F3 | 1 | 1.5 | 1.5 | — | 0.025 | — | — | 0-14 | Non- |
| | 2 | | | | 0.05 | | | | uniform |
| | 3 | | | | 0.1 | | | | size |
| | 4 | | | | 0.2 | | | | distributio |
| | 5 | | | | 0.3 | | | | n of beads |
| F4 | 1 | 1.5 | 1.5 | — | — | 0.1 | — | 0-14 | Spherical |
| | 2 | | | | | 0.2 | | | shape |
| | 3 | | | | | 0.3 | | | and |
| | 4 | | | | | 0.4 | | | uniform |
| | 5 | | | | | 0.5 | | | size of |
| | | | | | | 0.6 | | | beads |
| | | | | | | 1 | | | |
| | | | | | | 1.5 | | | |
| | | | | | | 2 | | | |
| F5 | 1 | 1.5 | 1.5 | — | — | — | 0.1 | 0-14 | Flat beads |
| | 2 | | | | | | 0.2 | | formed |
| | 3 | | | | | | 0.3 | | |
| | 4 | | | | | | 0.4 | | |
| | 5 | | | | | | 0.5 | | |
| | | | | | | | 0.6 | | |
| F6 | 1 | 1.5 | 1.5 | — | — | 0.5 | 0.05 | 0-14 | Irregular |
| | 2 | | | | | | 0.1 | | size of |
| | 3 | | | | | | 0.2 | | beads |
| | 4 | | | | | | | | |
| | 5 | | | | | | | | |

The emulsion prepared with defined composition was added dropwise into the cross-linking solution (CaCl₂) using a syringe. The formation of beads occurs soon after coming in contact with the CaCl₂ solution. The beads were washed and dried after being decanted from the excess CaCl₂ solution. The beads were shade dried at room temperature.

When beads were formulated using sodium alginate alone, beads were stuck together and remained adhered to the surface of the petri-plate upon drying.

The different combinations of polymer and co-polymers (along with surfactant; PEG 400 and cross-linking agent; CaCl₂) viz. sodium alginate with chitosan, sodium alginate with guar gum, sodium alginate with CMC (Caroxymethyl celluslose), and sodium alginate with guar gum and HPMC resulted in flattened, irregular beads formation and some batches showed that beads were shrunk after drying that resulted in shape distortion and non-uniform size distribution of beads (batch F1, F2, F3, F5 and F6).

The uniform distribution of polymeric beads was required for maintaining sustained release, dosage precision, beads stability, and regulatory compliance (to minimize batch to batch variation). It improves the safety, efficacy, and quality of formulation.

The sphericity of polymeric beads has significant effects on their mechanical and chemical stability. For example, it has been reported that nonspherical beads show lower gel bead strength than spherical beads. Breakage and cracking occurred on tear-shaped and nonspherical beads leading to the release of encapsulated essential oil. Further, the spherical beads improve appearance/aesthetic quality, which is a desirable factor for any product. Monodispersed and spherical polymeric beads are required to facilitate the sustained release of fennel oil to exert the desirable larvicidal effect for longer duration.

Batch F4 produced the spherical shaped uniform beads by taking sodium alginate as polymer and HPMC as co-polymer at the optimized concentration given in table 1.

TABLE 2
Effect of different surfactants on emulsion formation

| | Sodium | | PEG | | Span | Span | Tween | Cremophor | Fennel | |
|---|---|---|---|---|---|---|---|---|---|---|
| Batch | Alginate | HPMC | 400 | Glycerol | 20 | 80 | 20 | RH | oil | Obser- |
| Code | (% w/v) | (% w/v) | (% v/v) | (% v/v) | (% v/v) | (% v/v) | (% v/v) | (% v/v) | (% v/v) | vation |
| S1 | 1 | 0.1 | 1-10 | — | — | — | — | — | 1-14 | Stable |
| | 2 | 0.2 | | | | | | | | emulsion |
| | 3 | 0.3 | | | | | | | | formed |
| | 4 | 0.4 | | | | | | | | with no |
| | 5 | 0.5 | | | | | | | | separation |
| | | 0.6 | | | | | | | | |
| | | 1 | | | | | | | | |
| | | 1.5 | | | | | | | | |
| | | 2 | | | | | | | | |
| S2 | 1 | 0.1 | — | 1-10 | — | — | — | — | 1-14 | Separate |
| | 2 | 0.2 | | | | | | | | layer of oil |
| | 3 | 0.3 | | | | | | | | formed on |
| | 4 | 0.4 | | | | | | | | the |
| | 5 | 0.5 | | | | | | | | surface |
| | | 0.6 | | | | | | | | |
| | | 1 | | | | | | | | |
| | | 1.5 | | | | | | | | |
| | | 2 | | | | | | | | |
| S3 | 1 | 0.1 | — | — | 1-10 | — | — | — | 1-14 | Formed |
| | 2 | 0.2 | | | | | | | | mixture |
| | 3 | 0.3 | | | | | | | | was |
| | 4 | 0.4 | | | | | | | | excessively |
| | 5 | 0.5 | | | | | | | | opaque |
| | | 0.6 | | | | | | | | |
| | | 1 | | | | | | | | |
| | | 1.5 | | | | | | | | |
| | | 2 | | | | | | | | |
| S4 | 1 | 0.1 | — | — | — | 1-10 | — | — | 1-14 | Separate |
| | 2 | 0.2 | | | | | | | | layer of oil |
| | 3 | 0.3 | | | | | | | | was |
| | 4 | 0.4 | | | | | | | | formed |
| | 5 | 0.5 | | | | | | | | |
| | | 0.6 | | | | | | | | |
| | | 1 | | | | | | | | |
| | | 1.5 | | | | | | | | |
| | | 2 | | | | | | | | |
| S5 | 1 | 0.1 | — | — | — | — | 1-10 | — | 1-14 | Separate |
| | 2 | 0.2 | | | | | | | | layer of |
| | 3 | 0.3 | | | | | | | | the oil on |
| | 4 | 0.4 | | | | | | | | the |
| | 5 | 0.5 | | | | | | | | surface |
| | | 0.6 | | | | | | | | |
| | | 1 | | | | | | | | |
| | | 1.5 | | | | | | | | |
| | | 2 | | | | | | | | |
| S6 | 1 | 0.1 | — | — | — | 1-10 | 1-10 | — | 1-14 | Turbid |
| | 2 | 0.2 | | | | | | | | mixture |
| | 3 | 0.3 | | | | | | | | was |
| | 4 | 0.4 | | | | | | | | formed |
| | 5 | 0.5 | | | | | | | | |
| | | 0.6 | | | | | | | | |
| | | 1 | | | | | | | | |
| | | 1.5 | | | | | | | | |
| | | 2 | | | | | | | | |
| S7 | 1 | 0.1 | — | — | — | — | — | 1-10 | 1-14 | Unstable |
| | 2 | 0.2 | | | | | | | | emulsion |
| | 3 | 0.3 | | | | | | | | formed |
| | 4 | 0.4 | | | | | | | | |
| | 5 | 0.5 | | | | | | | | |
| | | 0.6 | | | | | | | | |
| | | 1 | | | | | | | | |
| | | 1.5 | | | | | | | | |
| | | 2 | | | | | | | | |

### Example 2

### Preparation of Beads Using Different Polymer Combinations

Preparation of beads was carried out by taking the trials with different polymer combinations such as the combination of sodium alginate with chitosan, sodium alginate with guar gum, sodium alginate with CMC (Carboxymethyl cellulose) and sodium alginate with HPMC (Hydroxypropyl methylcellulose).

Firstly, different solutions were prepared separately viz. sodium alginate with chitosan, sodium alginate with guar gum, sodium alginate with CMC (Carboxymethyl cellulose), and sodium alginate with CMC and HPMC dissolved in sufficient quantity of MiliQ water. Then 0.0-14.0% v/v of fennel oil mixed with 1.0-3.0% v/v of PEG 400 solutions were also prepared and these solutions were added in separate beakers containing pre-existing solutions of different polymers; sodium alginate (1-5% w/v) with chitosan (0.1-0.5% w/v), sodium alginate (1-5% w/v) with guar gum (0.1-0.6% w/v), sodium alginate (1-5% w/v) with CMC (Carboxymethyl cellulose) (0.02-0.3), and sodium alginate (1-5% w/v) with guar gum (0.05-0.2% w/v) and HPMC (0.1-2.0% w/v), sodium alginate (1-5% w/v) with HPMC (0.1-2.0% w/v) mixtures and stirred by using a magnetic stirrer at 1200-1500 rpm and continued the process for 30 minutes at room temperature (Heidolph, MR Hei-Tec). Eventually, one by one these solutions were subjected to sonication for 10 mins (1 sec on; 1 sec off) using a Probe Sonicator (Vibra Cell SONIC, VCX 750-220, Ultra Sonic Processor 750W, 220 V) to get homogenous emulsions.

The containers were covered by aluminium foil and kept in the ice bath throughout this process to avoid evaporation of the fennel oil and prevent heat production by vigorous stirring and sonication. Sonication facilitates the breakdown of the larger oil droplets into smaller ones and helps to disperse fennel oil uniformly. In different beakers, cross-linking calcium chloride solution (0.5-2.0% w/v) was prepared by dissolving CaCl₂ powder in distilled water separately.

The beads were prepared using the ionotropic gelation method to entrap the fennel oil in alginate beads. The emulsions of different polymer combinations were added dropwise into separate beakers containing the cross-linking solution (CaCl₂) using a syringe. The formation of beads occurs soon after coming in contact with the CaCl₂ solution due to the interaction between cations and anions. The beads were washed and dried after being decanted from the excess CaCl₂ solution. The beads were shade-dried at room temperature. A detailed description/observation of the beads prepared using different polymer combinations is given in Table 1.

### Example 3

### Preparation of Beads for Mosquito Larvicidal Action

1.5% v/v of PEG 400 was mixed with 10% v/v of fennel oil, the prepared solution was then poured into sodium alginate (4% w/v) and HPMC (0.6% w/v) premixed solution in sufficient quantity of MiliQ water and stirred by using a magnetic stirrer at 1200-1500 rpm and continued the process for 30 minutes at room temperature (Heidolph, MR Hei-Tec). Eventually, the solution was subjected to sonication for 10 mins (1 sec on; 1 sec off) using a Probe Sonicator (Vibra Cell SONIC, VCX 750-220, Ultra Sonic Processor 750W, 220 V) to get a homogenous emulsion. The container was covered by aluminium foil and kept in the ice bath throughout this process to avoid evaporation of the fennel oil and prevent heat production by vigorous stirring and sonication. Sonication facilitates the breakdown of the larger oil droplets into smaller ones and help to disperse fennel oil uniformly. Cross-linking calcium chloride solutions (1.5% w/v) was prepared by dissolving CaCl₂ powder in distilled water. The beads were prepared using the ionotropic gelation method to entrap the fennel oil in alginate beads. The emulsion was added dropwise into the cross-linking solution (CaCl₂) using a syringe. The formation of beads occurs soon after coming in contact with the CaCl₂ solution due to the interaction between cations and anions. The beads were washed and dried after being decanted from the excess CaCl₂ solution. The beads were shade-dried at room temperature.

### Example 4

TABLE 3
Optimization of fennel oil content in the formulation
Composition of Emulsion

| | Sodium | PEG | | | Fennel | |
|---|---|---|---|---|---|---|
| Batch | Alginate | 400 | CaCl₂ | HPMC | oil | |
| Code | (% w/v) | (% v/v) | (% w/v) | (% w/v) | (% v/v) | Observation |
| E1 | 1 | 1.5 | 1.5 | 0.6 | 2 | The small |
| | 2 | | | | | amount of |
| | 3 | | | | | fennel oil |
| | 4 | | | | | resulted in |
| | 5 | | | | | lower loading |
| | | | | | | in beads |
| E2 | 1 | 1.5 | 1.5 | 0.6 | 5 | The amount of |
| | 2 | | | | | fennel oil was |
| | 3 | | | | | not optimum to |
| | 4 | | | | | form stable |
| | 5 | | | | | emulsion. |
| E3 | 1 | 1.5 | 1.5 | 0.6 | 8 | Optimum |
| | 2 | | | | | loading of |
| | 3 | | | | | fennel oil was |
| | 4 | | | | | not achieved to |
| | 5 | | | | | maximize the |
| | | | | | | mortality. |
| E4 | 1 | 1.5 | 1.5 | 0.6 | 10 | A stable |
| | 2 | | | | | emulsion with |
| | 3 | | | | | optimum |
| | 4 | | | | | loading |
| | 5 | | | | | (78.56%) |
| | | | | | | of fennel oil |
| | | | | | | was achieved. |
| E5 | 1 | 1.5 | 1.5 | 0.6 | 12 | The stable |
| | 2 | | | | | emulsion was |
| | 3 | | | | | not formed to |
| | 4 | | | | | get the desired |
| | 5 | | | | | effect. |
| E6 | 1 | 1.5 | 1.5 | 0.6 | 14 | Phase |
| | 2 | | | | | separation was |
| | 3 | | | | | observed |
| | 4 | | | | | leading to |
| | 5 | | | | | unstable |
| | | | | | | emulsion. |

Different amount of fennel oil was taken in batches E1, E2, E3, E4, E5 and E6 (as given in Table 3) for the preparation of emulsion and converting the same in to polymeric beads. To achieve the maximum oil loading in polymeric beads with spherical shape and uniform size to get the desired extended release and larvicidal activity, all the above batches were evaluated for emulsion stability and it was found that batch E4 was giving the 100% larval mortality.

### Example 5

### Characterization of Fennel Oil

The chemical composition of fennel oil was identified by Gas-chromatography-Mass spectroscopy (GC-MS). A total of seventy-one phyto-constituents were identified; among them, anethole (1-methoxy-4- [(1E)-prop-1-en-1-yl] benzene) was quantified as the most abundant (about 66.07%) component. The other most prevalent compounds are estragole (19.17%), D-limonene (5.48%), L-fenchone (3.39), and Benzaldehyde-4-methoxy (1.63%).

### Example 6

### Characterization of Emulsion: Optical Microscopy of Emulsion

The oil droplet distribution was measured using an optical microscope before and after sonication. The samples were prepared by spreading a drop of emulsion on a glass slide, covered with a covering slip, and observed under the microscope.

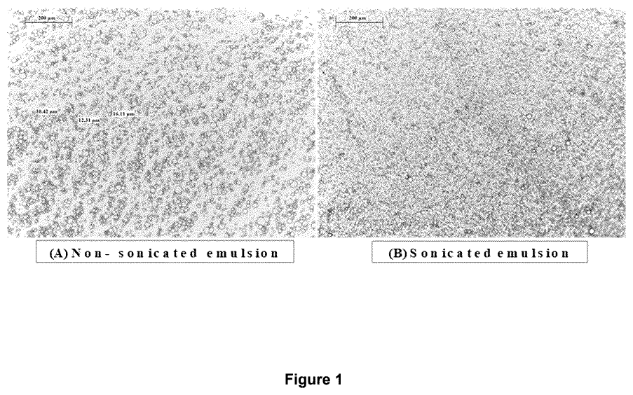

FIG. 1 shows the homogenous distribution of oil droplets determined by Optical Microscopy before and after the sonication process and analysed the effect of ultra-sonication on the oil droplet distribution parameter.

### Particle Size Distribution and Polydispersity Index (PDI) of Emulsion

Particle size distribution and polydispersity index (PDI) of the emulsion were determined by DLS using Zetasizer nanoZS (Malvern Instrument Ltd. Malvern).

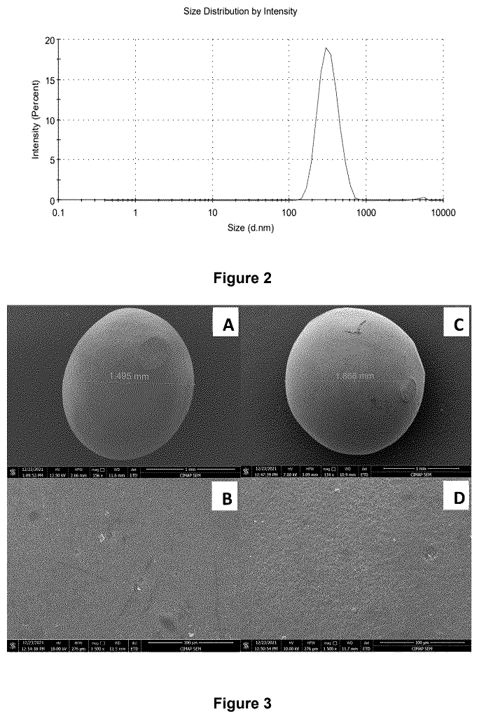

The average droplet size of the emulsion was 363.8±6.60 nm with 0.349±0.021 polydispersity index. Histogram of the particle size distribution of the emulsion is shown in FIG. 2. Smaller particle size is required for enhanced emulsion stability.

### Viscosity

Brookfield viscometer (DV-II+Pro) was used to measure the viscosity of the alginate-fennel essential oil emulsion. The viscosity was measured with a small spindle sample adapter (model SS-18). A 5mL emulsion was placed in a small sample adapter, and the viscosity was recorded in centipoise (cP).

The polymer (sod. alginate) and co-polymer (HPMC) ratio appeared to be the most crucial factor influencing the viscosity of the emulsion. The viscosity of fennel oil loaded emulsion is given in Table 4. Creaming was slowed at higher polymer concentrations because emulsion droplets cannot move freely due to the high viscosity.

TABLE 4
The viscosity of fennel oil loaded emulsion at different RPM.

| | Fennel oil emulsion |
|---|---|
| RPM | Viscosity (Cₚ) |
| 20 | 16684 |
| 50 | 9036 |
| 100 | 4518 |

### Stability of Emulsion

The physical stability of the emulsion was determined using the procedure described by Chan, 2011, in which 10 mL of the emulsion was placed in a test tube that was kept at room temperature for 2 hours to determine the phase separation. Phase separation (creaming) in the emulsion is an indication of instability. The following equation was used to calculate the emulsion stability(ES) (1) (Chan, 2011).

$$ES ( \% ) = \frac{Vemul .}{Vinitial} \times 100 \qquad ( 1 )$$

Where, V_{emul.} and Vᵢₙᵢₜᵢₐₗ are the volume of the remaining emulsion after 2 hours and the initial volume of the emulsion, respectively.

During the stability study, no phase separation was seen. The instability of the emulsion could hinder the beads production, and the emulsion must have no phase separation. The entire process of formulation takes about 1-2 hours. As a result, until the formulation is completed, an emulsion in a stable environment is required. A higher alginate concentration could improve emulsion stability by increasing solution viscosity, evident during the optimization process. Polymers can form a three-dimensional network at higher concentrations that can retain oil droplets within entangled polymer chains.

### Example 7

### Characterization of Polymeric Beads

### Determination of Loading Capacity (LC)

Essential oil loading was determined by UV/VIS spectroscopy (Thermo Scientific Model no. 225/A1) at 258 nm and described as follows: 20 mg sample was crushed in 80% ethanolic aqueous solution, and its concentration was calculated by using the calibration curve [Eq. (2)]. All analyses were carried out in triplicate.

$$y = 0 \text{.0954} x + 0.0392 ; {R}^{2} : 0.9966 \qquad Eq ( 2 )$$

Where y is the absorbance, and x is the fennel oil concentration.

Fennel oil encapsulation efficiency (EE) was determined using the following equation as:

$$\% EE = \frac{M}{Mo} \times 100 \qquad Eq ( 3 )$$

Where,

M=Actual amount of fennel oil determined in the sample

Mo=Initial amount of fennel oil added

Drug loading is given by the ratio of the mass of fennel essential oil and the mass of dry beads.

$$\% LC = \frac{Actual Drug content}{total weight of the beads} \times 100 \qquad Eq ( 4 )$$

Shade-dried beads were compact due to the substantial crosslinking of polymers with calcium ions during bead formation, which could encapsulate a sufficient amount of drug in the polymeric matrices. The entrapment efficiency and loading capacity of dried beads were 79.08±0.22% and 78.56±0.309%, respectively.

### Morphology and Size Determination of Polymeric Beads

The shape and size of the beads were determined using an optical microscope (LEICA ICC50 HD) equipped with a camera and data acquisition system. The shape and sphericity of the beads were determined by calculating their roundness by the Sphericity Factor (SF) and Aspect Ratio (AR). A high SF value indicates that the particle is distorted, whereas a zero value indicates that the particle is a perfect sphere. The AR and SF can be evaluated using the following Eq. 5 and Eq. 6, respectively (Chan et al., 2009; Volić et al., 2018, Morales et al., 2017; Gholamian et al., 2021).

$$AR = \frac{dmax}{dmin} \qquad Eq ( 5 )$$

$$SF = \frac{dmax - dmin}{dmax + dmin} \qquad Eq ( 6 )$$

Where dₘₐₓ is the maximum diameter passing through a bead centroid, and dmin is the diameter measured perpendicular from its centroid.

The particle size, morphology, and surface topography of the polymeric beads (dried fennel oil loaded beads) were analyzed under scanning electron microscopy (SEM) (430 LEO, Carl Zeiss, Germany, UK) using polaron sputter coater and gold platinum alloy as a coating material. The beads were mounted on a double-sided adhesive tape stuck to a gold-coated (thickness ˜250 Å) stub. Images were taken randomly at 100× magnification (Paula et al., 2011). The acceleration voltage during the observation was 12.50 kV.

Although all of the beads were produced using the same method under similar conditions, there were slight variations in the shape and size of the beads. The mean diameter of the smallest bead was found to be approx. 1.49 mm, while the largest bead was approx. 1.86 mm (FIG. 3). The shape was estimated using the aspect ratio (AR) and the sphericity factor (SF), where the aspect ratio describes large deformations but suppresses minor distortions. AR value 1 denotes a perfect sphere. On the other hand, the sphericity factor can more effectively describe the relative change of the shape. SF value ranging from 0 shows an ideal spherical shape. SF value lesser than 0.05 is considered spherical (Table 5).

TABLE 5
Dimensions (Maximum diameter and Minimum diameter), shape
indicators (Aspect Ratio and Sphericity factor) of fennel oil beads

| | Wet beads | | Dry beads | | | | SF = dₘₐₓ − dₘᵢₙ/ | |
|---|---|---|---|---|---|---|---|---|
| | dₘᵢₙ | dₘₐₓ | dₘᵢₙ | dₘₐₓ | AR = dₘₐₓ/dₘᵢₙ | | dₘₐₓ + dₘᵢₙ | |
| Beads | (mm) | (mm) | (mm) | (mm) | AR_{w} | AR_{d} | SF_{w} | SF_{d} |
| Fennel | 2.71 | 2.73 | 1.76 | 1.88 | 1.007 | 1.068 | 0.0036 | 0.032 |
| oil | | | | | | | | |
| Beads | | | | | | | | |

dₘₐₓ-maximum diameter,
dₘᵢₙ-minimum diameter,
AR_{w}-Aspect ratio of wet beads,
AR_{d}-Aspect ratio of dry beads,
SF_{w}-sphericity factor of wet beads,
SF_{d}-sphericity factor of dry beads,
s.d.-standard deviations.

The morphology and surface topography of dried beads were evaluated using scanning electron microscopy, as shown in FIG. 3. SEM micrographs showed reasonable spherical shapes for fennel oil beads.

### In-Vitro Release

In-vitro release studies of plain fennel oil and fennel oil-loaded polymeric beads were performed using a dialysis membrane method. The dialysis bag was first soaked in distilled water and rinsed thoroughly for activation and to wash off the preservatives before use. The in-vitro release of fennel oil-loaded beads was evaluated by placing a determined mass of beads (50 mg) in a dialysis bag and placing the dialysis membrane in a beaker with 100 ml solution (ethanol and distilled water in a 1:1 ratio). The solution was continuously stirred at 100 RPM and maintained temperature at 25° C. 1mL aliquot from the solution was withdrawn at pre-determined time intervals and replenished with the fresh solution of ethanol and distilled water to maintain the sink condition and constant volume of the medium. The samples were analyzed using a UV spectrophotometer at 258 nm. The concentration of the oil present in the medium was calculated using Eq. (1). The in-vitro release of plain fennel oil was also performed using the same method. All measurements were taken in triplicates (Solomon et al., 2012).

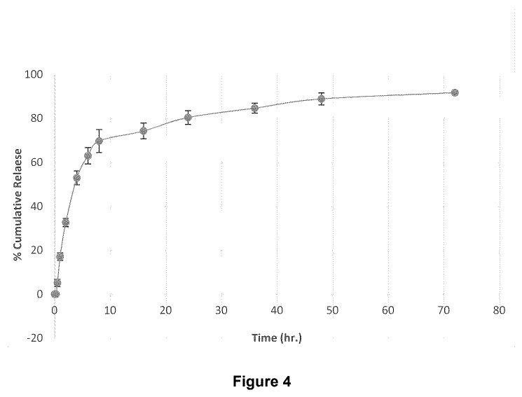

The in-vitro release of the pure fennel oil and fennel oil from the beads for 72 hours is illustrated in FIG. 4. From dialysis membrane, the release was slow when the oil was encapsulated in a polymer matrix. The cumulative release of fennel oil was observed 91.66±0.47% at 72 hours from the beads, because polymer(s) were used to encapsulate the fennel oil. As a result, thick wall matrices with narrow pore sizes were formed. Thus, it was effective in achieving a slower release. The release pattern of volatile compounds was impacted by varying the concentration of polymers, especially the proportion of sodium alginate; moreover, with the increase in alginate concentration, the activity of fennel oil can be extended for the desired period.

### Example 8

### Mosquito Larvicidal Bioassays

Larvae of Aedes aegypti, Anopheles stephensi, and wild mosquitoes were maintained in the Herbal Medicinal Product Development Lab, CSIR-CIMAP, Lucknow, U.P. (India). The common standard procedure of mosquito rearing technique was followed during the experiment (Champakaew et al., 2015). The mosquito colony was maintained at 25-30° C. and 70-80% relative humidity under a photoperiod of 12:12 h (light/dark), free of exposure to pathogens or insecticides. Freshly molted larvae of Aedes aegypti, Anopheles stephensi, and wild mosquitoes were continuously available for larvicidal experiments.

The effectiveness of fennel oil and fennel oil-loaded beads were observed in the in-vivo mosquito larvicidal experiments. The samples were tested for larvicidal activity against 3rd instar Aedes aegypti, Anopheles stephensi, and wild mosquito larvae for 24 hours. As per our study on pure fennel oil for mosquito larvicidal activity, it showed 100% mortality in 24 hours at 32ppm (Table 6). Therefore, in the present study, 144-500 mg placebo beads and fennel oil beads were placed in individual beakers and it was observed that fennel oil-loaded beads killed Aedes aegypti, Anopheles stephensi, and wild mosquito larvae within 24 hours (Table 6).

TABLE 6
Efficiency of fennel oil and fennel oil-loaded beads for larval mortality

| | % Mosquito Larval mortality (in 24 hrs) | | | | | |
|---|---|---|---|---|---|---|
| | | | | | | Fennel |
| | | | | | | oil- |
| | Fennel oil | | | | Placebo | loaded |
| Mosquitoes | 8 ppm | 16 ppm | 24 ppm | 32 ppm | Beads | beads |
| Aedes | 20.0 | 52.8 | 79.2 | 100 | No | 100 |
| aegypti | | | | | Mortality | |
| Anopheles | 0.0 | 0.0 | 44.8 | 100 | No | 100 |
| stephensi | | | | | Mortality | |
| Wild larvae | 8.0 | 56.0 | 88.0 | 100 | No | 100 |
| | | | | | Mortality | |

### ADVANTAGES OF INVENTION

1. The formulation that is effective against different species of mosquitoes.
2. The effect of said composition on the mosquito larvicidal activity of different species and helping in the reduction of mosquitoes population.
3. Pure fennel oil for mosquito larvicidal activity showed 100% mortality in 24 hours at 32ppm

We claim

1. A fennel oil-loaded polymeric beads for mosquito larvicidal activity wherein the said beads are in the size range of 1.49 mm to 1.86 mm.

2. The fennel oil-loaded polymeric beads of claim 1, wherein the entrapment efficiency of dried beads was 53.90-79.08% and its loading capacity was 47.7-78.56%.

3. The fennel oil-loaded polymeric beads of claim 1, wherein the said polymeric beads demonstrated extended in-vitro release of the fennel oil from the beads with cumulative release of fennel oil in the range of 52.90% to 91.66% in a period in the range of 4 to 72 hours.

4. The fennel oil-loaded polymeric beads of claim 1, wherein the said beads are effective in controlling Aedes agypti, Anopheles stephensi, and wild mosquito larvae and provide 100% mortality of Aedes aegypti, Anopheles stephensi, and wild mosquito larvae within 24 hours of contact.

5. A process for preparing micro spherical polymeric beads of claim 1, wherein the said process comprises with steps of:
i. mixing 1.0-3.0% v/v of PEG 400 with 0.0-14.0% v/v of fennel oil to obtain a solution,
ii. mixing solution obtained in step (i) with 1.0-5.0% w/v sodium alginate and 0.1-2.0% w/v HPMC and stirring at 1200-1500 rpm for 30 minutes at temperature in the range of 25-35° C. followed by sonicating for 10 mins on ice bath to obtain a micro emulsion,
iii. fabricating beads by adding the micro emulsion obtained in step (ii) dropwise in cross-linking solution of 0.5-2.0% w/v CaCl₂ to obtain wet polymeric beads,
iv. washing the polymeric beads obtained in step (iii) and shade drying the same at temperature in the range of 25-35° C. after decanting excess CaCl₂ crosslinking solution to obtain dried fennel oil loaded beads.

6. The process of claim 5, wherein the polymers are selected from sodium alginate, HPMC, chitosan, guar gum, and CMC (Carboxymethyl cellulose).

7. The process of claim 5, wherein the surfactant is selected from Span 20, Span 80, PEG 400, Cremophor RH 40, and Tween 20.

8. The process of claim 5, wherein the crosslinking solution used is CaCl₂.
